(19) United States
(12) Patent Application Publication
(10) Pub. No.: US 2017/0161148 A1
(43) Pub. Date: Jun. 8, 2017

(54) DETECTION OF AND RECOVERY FROM SILENT DATA LOSS IN AN ERASURE-CODED STORAGE SYSTEM

(71) Applicant: NetApp, Inc., Sunnyvale, CA (US)

(72) Inventors: Emalayan Vairavanathan, Vancouver (CA); Dheeraj Raghavender Sangamkar, Vancouver (CA); Viswanath Chandrasekara Bharathi, Bangalore (IN)

(21) Appl. No.: 15/275,046

(22) Filed: Sep. 23, 2016

Related U.S. Application Data
(60) Provisional application No. 62/262,202, filed on Dec. 2, 2015.

(51) Int. Cl. G06F 11/14; G06F 11/10

(52) U.S. Cl. CPC G06F 11/1435; G06F 11/1076; G06F 2211/109

(57) ABSTRACT

Techniques are disclosed for detection of loss or corruption among data chunks (i.e. silent data loss) corresponding to an object stored in an erasure-coded storage system. In one embodiment, one of the data chunks stored in a storage node is selected for integrity verification. The storage node computes a current checksum for the selected data chunk. The integrity of the data chunk is determined based upon a comparison of the current checksum for the data chunk with a stored checksum for the data chunk. In response to the checksums differing, the storage node requests recovery of the data chunk from the erasure-coded storage system. The data chunk is stored by the storage node if the data chunk is recovered.

### BACKGROUND

The disclosure generally relates to the field of data processing, and more particularly to data storage.

In a large-scale distributed storage system, individual storage nodes will commonly fail or become unavailable from time to time. Therefore, storage systems typically implement some type of recovery scheme for recovering data that has been lost, degraded or otherwise compromised due to node failure or otherwise. One such scheme is known as erasure coding. Erasure coding generally involves the creation of codes used to introduce data redundancies (also called “parity data”) that is stored along with original data (also referred to as “systematic data”), to thereby encode the data in a prescribed manner. If any systematic data or parity data becomes compromised, such data can be recovered through a series of mathematical calculations.

Erasure coding for a storage system involves algorithmically splitting a data file of size M into X chunks (also referred to as “fragments”), each of the same size M/X. An erasure code is applied to each of the X chunks to form A encoded data chunks, which again each have the size M/X. The effective size of the data is A*M/X, which means the original data file M has been expanded by (A−X)*(M/X), with the condition that A≧X. Now, any X chunks of the available A encoded data chunks can be used to recreate the original data file M. The erasure code applied to the data is denoted as (n, k), where n represents the total number of nodes across which all encoded data chunks will be stored and k represents the number of systematic nodes (i.e., nodes that store only systematic data) employed. The number of parity nodes (i.e., nodes that store parity data) is thus n−k=r. Erasure codes following this construction are referred to as maximum distance separable (MDS), though other types of erasure codes exist.

Data loss occurs frequently in large-scale distributed storage systems. In such systems, data is often stored on hard drives that are composed of moving mechanical parts, which are prone to failure. In some instances, such as a complete hard drive failure, the data loss is detected, and a recovery of the lost data can be initiated. In other instances, data loss can go undetected (also referred to as “silent data loss”). One cause of silent data loss is disk drive unreliability. For example, the read-and-write head of the drive can touch the spinning platter causing scratches that lead to block corruption or block failures (latent sector errors) within disk drives. Furthermore, the frequency of block failures and block corruption is expected to increase, due to higher areal densities, narrower track widths, and other advancements in media recording technologies. Another cause of data loss is errors (“bugs”) in firmware code and/or in the operating systems that are employed. Hard drives, controllers, and operating systems consist of many lines of complex firmware and software code, thus increasing the potential for having critical software bugs that may cause data loss, where the data may get silently corrupted on the data path without getting noticed.

In the context of an erasure-coded storage system, this silent data-loss may result in lost or corrupted data chunks. Therefore, in order to improve reliability, what is needed is a way to identify and correct lost or corrupted data chunks in an erasure-coded storage system.

### BRIEF DESCRIPTION OF THE DRAWINGS

Aspects of the disclosure may be better understood by referencing the accompanying drawings.

FIG. 1 is a block diagram illustrating an example of a (4, 2) erasure code applied to a data file M.

FIG. 2 is a block diagram illustrating an example of an erasure code that is applied along with integrity verification data.

FIG. 3 is a flowchart depicting an example of a method for background detection of and recovery from corrupted or lost data chunks stored in an erasure coded storage system.

FIG. 4 is a flowchart depicting another example of a method for detection of and recovery from corrupted or lost data chunks stored in an erasure coded storage system.

FIG. 5 is a block diagram illustrating an example of a computing environment in which various embodiments may be implemented.

### DESCRIPTION

### Overview

The various embodiments described herein provide an approach for identifying and recovering from silent data loss in an erasure-coded storage system. Embodiments include methods, systems and corresponding computer-executable instructions for detecting corrupted data chunks through use of checksums calculated and stored along with the individual data chunks in the storage nodes. On an intermittent and/or event-driven basis, an individual storage node can re-calculate a checksum of a given data chunk stored for an object, i.e. a data file. Any change of the content of the data chunk, such as can occur with silent data loss, will result in a changed checksum value. Thus, by comparing the stored checksum for the data chunk with the re-calculated checksum, any corruption in the data chunk can be detected. Once detected, the erasure-coded storage system can begin the recovery operations to re-generate the corrupted data chunk, so long as the requisite number of other data chunks for the object are available within the storage system. As discussed above, the exact number of data chunks required to rebuild a data chunk depends upon the particular configuration of the erasure coding scheme under which the object was originally stored, and the embodiments disclosed herein support the use of various different types of erasure codes and encoding schemes.

### Example Illustrations

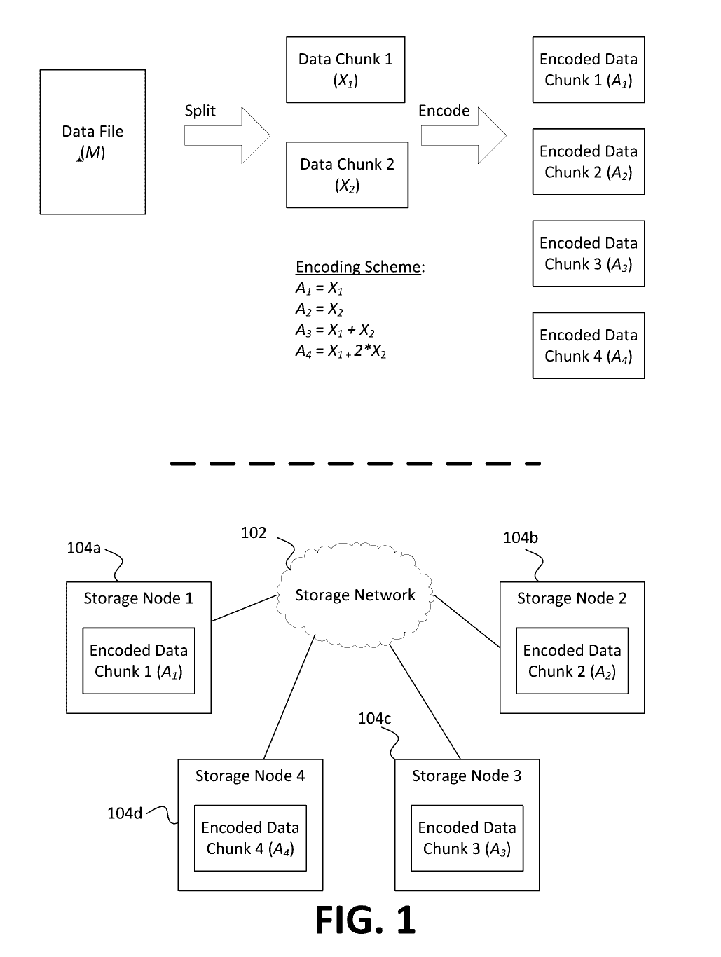

FIG. 1 depicts an example of a (4, 2) erasure code applied to a data file M. As shown, a data file M is split into two chunks X₁, X₂ of equal size and then an encoding scheme is applied to those chunks to produce 4 encoded chunks A₁, A₂,A₃, A₄. By way of example, the encoding scheme may be one that results in the following relationships: A₁=X₁; A₂=X₂; A₃=X₁+X₂; and A₄=X₁+2*X₂. In this manner, the 4 encoded data chunks can be stored across a storage network 102, such that the one encoded data chunk is stored in each of four storage nodes 104a-d. Then, the encoded data chunks stored in any 2 of the four storage nodes 104a-d can be used to recover the entire original data file M. This means that the original data file M can be recovered if any two of the storage nodes 104a-d fail, which would not be possible with traditional “mirrored” back-up data storage schemes.

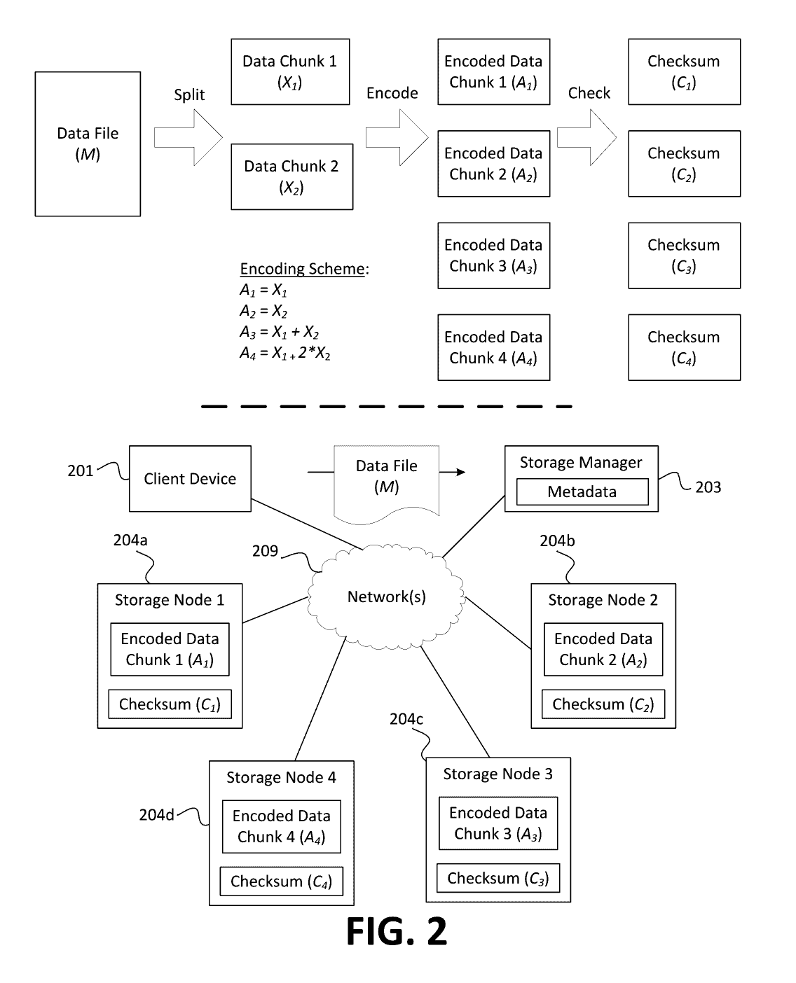

FIG. 2 depicts an example of a (4, 2) erasure code applied to a data file M that also incorporates data corruption detection and recovery techniques. As shown, the client device 201 requests to store the data file Min a storage system made up of a storage manager 203, storage nodes 204a-d, and possibly other devices not shown in detail. Storage nodes 204a-d may be located in different geographical areas and may thus be referred to as “geo-distributed storage nodes.” While the storage manager 203 is represented as a single device, the functionality described below for the storage manager 203 may be performed by one or more devices. Communication among these various computing devices is facilitated by one or more networks 209. Once received by the storage manager 203, the data file M is split into two chunks X₁, X₂ of equal size and then the encoding scheme is applied to those chunks to produce four encoded chunks A₁, A₂, A₃, A₄. In this example, the encoding scheme results in the following relationships: A₁=X₁; A₂=X₂; A₃=X₁+X₂; and A₄=X₁=2*X₂. In this manner, the four encoded data chunks can be transmitted across a network 209 for storage, such that the one encoded data chunk is stored in each of four storage nodes 204a-d. The storage manager 203 may then record various metadata associated with the storage operation, such as the identifiers for the data file M and the data chunks of which it is composed, the encoding scheme and other parameters of the erasure code used, address information of each storage node used and the corresponding identifier of the data chunk stored there, and/or other possible information.

Thereafter, each storage node 204a-d calculates a checksum of the data chunk it received and stores the checksum value along with the data chunk. The checksum function used can include one or more of MD-4/5 (Message Digest), SHA-0/1/2/3 (Secure Hash Algorithm), and/or other possible checksum functions (also referred to as “cryptographic hash functions”) as can be appreciated. In some embodiments, the storage manager 203 can compute the checksums of the data chunks and transmit both the data chunks and the corresponding checksums to the storage nodes 204a-d to be stored.

Once the data chunks are stored on the storage nodes 204a-d, a substantial amount of time may elapse before the data file M (the object) is requested, thereby increasing the likelihood that silent data loss occurs before the object is needed. To address this problem, each of the storage nodes 204a-d can independently perform “background” integrity checks of its stored data chunks, which may include other data chunks for other objects not shown. The integrity checks can be referred to as “background” due to the fact that this integrity checking operations may be run concurrently with other operations of the storage node and without a particular data chunk being requested before its integrity is verified. For example, storage node 204a can re-compute the checksum of data chunk 1 (A₁), as well as re-compute the checksums of any other data chunks (not shown) stored by storage node 204a. As discussed above, any change in the content of a data chunk, such as can occur with silent data loss, will result in a changed checksum value. Thus, by comparing the stored checksum (C₁) for the data chunk with the re-calculated checksum, any corruption in the data chunk can be detected. The background data integrity checks can be performed on a periodic and/or random basis. For example, background data integrity checks can be performed once per month or at any other frequency deemed suitable. Such a frequency may be set and modified by a network administrator or other operator, or by way of a software algorithm. In another example, the frequency at which background data integrity checks are performed can be “tuned” based upon detections of integrity failures. In other words, as integrity failures are detected (or repeatedly detected), the frequency at which background data integrity checks are performed may be increased.

In the event that a storage node 204a-d determines that the checksums for a given data chunk do not match (i.e. the data chunk is corrupted), the respective storage node can request the storage manager 203 to recover the data chunk. Prior to recovering the data chunk, the storage manager determines if the essential number of other chunks for the encoded object are available. As can be appreciated, the essential number of chunks (k) required to re-generate the object depends upon the encoding scheme used to encode the object. For example, in FIG. 2 the (4, 2) encoding scheme was used to produce two chunks of systematic data (k=2) and two chunks of parity data. Thus, based on the encoding scheme used for the object (i.e. the data file M), the storage manager 203 determines that if any two data chunks for the object are available, regardless of whether the available data chunks are systematic data, parity data, or a mix, then the corrupted data chunk can be recovered. To that end, the storage manager 203 attempts to retrieve the essential number of data chunks from the remaining storage nodes and reconstructs the corrupted data chunk using the erasure codes, as can be appreciated. Once reconstructed, the data chunk is returned to the storage node, where it will be again be stored.

Alternatively, if an essential number of data chunks are not available on the other storage nodes (e.g. some of these other data chunks are themselves corrupted), the storage manager 203 notifies the storage nodes that the data chunks for the object should be deleted. In some embodiments, the storage manager may also attempt to recover any unavailable data chunks from a backup, archive, and/or other alternative data storage, if it exists, prior to notifying the storage nodes to delete the remaining data chunks for the obj ect.

In addition to background checks of data chunks, the storage nodes may also perform integrity checks of the data chunks as they are requested by a client device 201 and/or by other workflows of the storage system. For example, as the client device 201 makes a request to the storage manager 203 for retrieval of the data file M previously stored, the storage manager 203 requests the systematic data that make up the data file M, chunks Ai and Az, stored in the storage nodes 204a and 204b, respectively. Thereafter, storage nodes 204a-b re-calculate the checksum of the respective data chunks and compare the re-calculated checksums to the corresponding stored checksums. For each requested data chunk whose re-calculated and stored checksums match (i.e. integrity verified), the requested data chunk may be provided to the storage manager 203. If all the systematic data chunks that are requested are verified, the storage manager 203 reconstitutes the data file M and provides it to the client 201. In the event a requested data chunk has been corrupted (i.e. its recalculated checksum does not match its stored checksum), the storage node that detects the corruption notifies the storage manager 203 of the failure. In different embodiments, in order to retrieve the data file M, the storage manager 203 may request all the data chunks, parity data chunks, systematic data chunks, or a mix of parity and systematic data chunks.

Once notified, the storage manager 203 attempts to identify other data chunks (i.e. parity data chunks) from which the corrupted systematic data chunk can be reconstructed based on the erasure code. If the storage manager 203 can obtain the essential number of data chunks from the storage nodes 204a-d, any corrupted data chunks can be reconstructed, such that the data file M is reconstituted and provided to the client 201. In addition, any data chunks that were found to have been corrupted will be replaced with a proper, recovered version of the same data chunk(s) reconstructed from the other data chunks. Alternatively, if an essential number of data chunks cannot be obtained from the storage nodes 204a-d (e.g. some of these other data chunks are themselves corrupted), the storage manager 203 notifies the client 201 of the failure retrieving the file and notifies the storage nodes 204a-d that the data chunks for the object should be deleted. In some embodiments, the storage manager 203 may also attempt to recover any unavailable data chunks from a backup, archive, and/or other alternative data storage, if it exists, prior to notifying the storage nodes 204a-d to delete the remaining data chunks for the object.

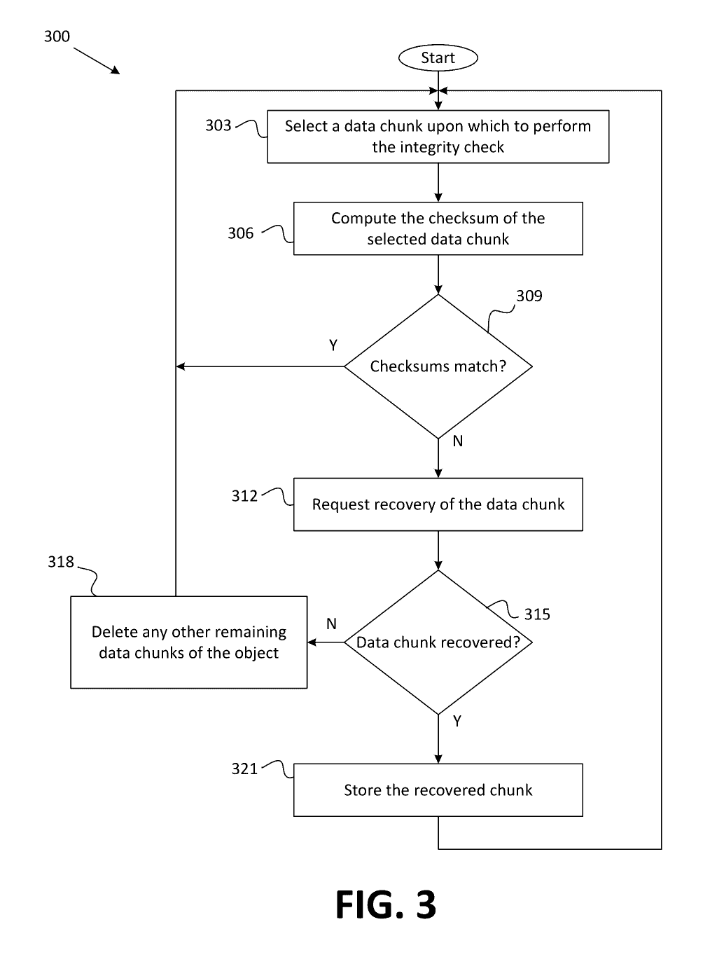

Referring next to FIG. 3, shown is a flowchart that provides one example of the operation of a portion of the functionality implemented in a storage node according to various embodiments. It is understood that the flowchart of FIG. 3 provides merely an example of the many different types of functional arrangements that may be employed to by the storage node as described herein. As an alternative, the flowchart of FIG. 3 may be viewed as depicting an example of elements of a method 300 implemented in the storage node according to one or more embodiments. The functionality of FIG. 3 may be initiated in response to a request to begin background checking of data chunks stored by a storage node.

Beginning with block 303, the storage node selects a data chunk upon which to perform the integrity check, where the data chunk may be selected from among a plurality of data chunks stored by the storage node. The storage node may select data chunks for integrity checking using various possible schemes such as random selection, time since last integrity check, proximity to other failed data chunks, and/or using other possible schemes. In some implementations, the storage node obtains, from the metadata of the storage manager, a list of the data chunks that are expected to have been stored by the storage node. The storage node may then confirm that some or all of the data chunks that are expected to have been stored are actually stored by the storage node. By obtaining the list of data chunks from the storage manager, the storage node can confirm not only the integrity of its known data chunks, but also that the storage node has not silently lost track of any of its data chunks (e.g. as a result of silent data loss). In the event a data chunk is determined to have been lost by the storage node, the storage node may request the storage manager to re-generate the lost data chunk so it may be properly stored by the storage node.

Next, in block 306, the storage node re-computes the checksum of the selected data chunk, where the computation includes reading the data chunk as it is stored in the storage medium of the storage node. As can be appreciated, the storage node may use MD-4/5, SHA-0/1/2/3, and/or other possible cryptographic hash algorithms to compute the checksum. Any change in the content of the data chunk from the time it was originally stored by the storage node, such as can occur with silent data loss, will result in a changed checksum value. Then, in block 309, the storage node determines whether the stored checksum for the data chunk matches the re-calculated checksum by performing a comparison. If the checksums match, (i.e. verifying the integrity of the checksum) execution returns to block 303 where another data chunk may be selected for verification. Alternatively, if the checksums for the data chunk do not match (i.e. the data chunk is corrupted), in block 312, the storage node can request the storage manager to recover the data chunk, where the recovery may be based on the remaining data chunks stored for the object.

Subsequently, in block 315, the storage node determines whether the storage manager has been able to recover the data chunk. If not, in block 318, the storage node deletes the data chunk and any other data chunks stored for the object by the storage node. Alternatively, in block 321, the storage node receives the recovered data chunk from the storage manager and stores the data chunk in its storage medium. Thereafter, execution returns to block 303 where another data chunk may be selected for verification.

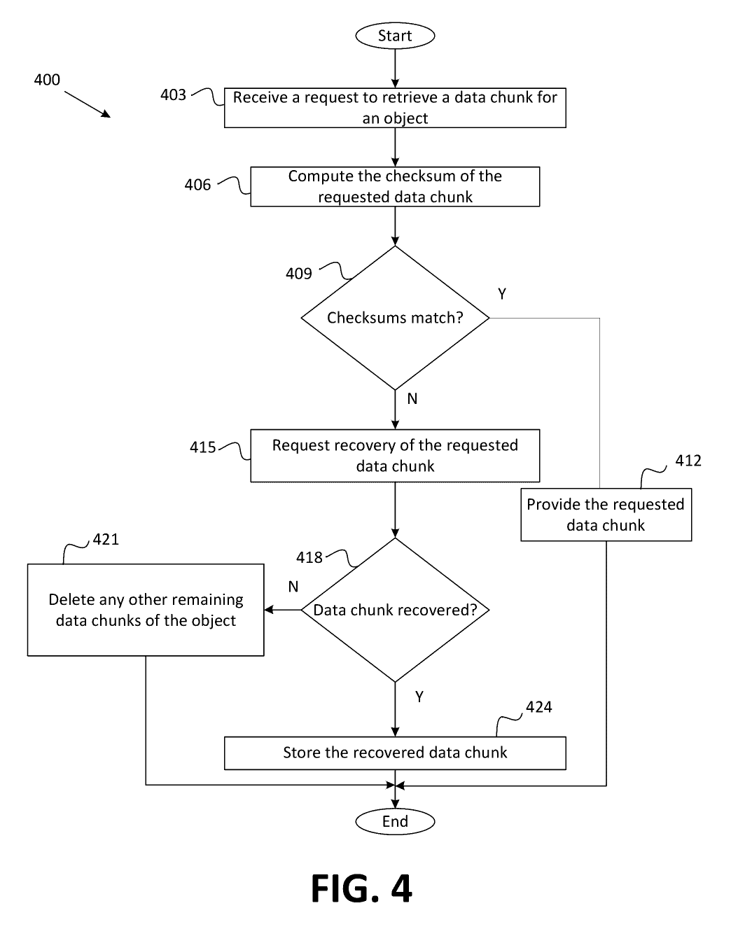

Referring next to FIG. 4, shown is a flowchart that provides an example of the operation of another portion of the functionality implemented in a storage node according to various embodiments. It is understood that the flowchart of FIG. 4 provides merely an example of the many different types of functional arrangements that may be employed to by the storage node as described herein. As an alternative, the flowchart of FIG. 4 may be viewed as depicting an example of elements of a method 400 implemented in the storage node according to one or more embodiments. The functionality of FIG. 4 may be initiated in response to a storage manager or other component of a storage system needing to access a data chunk for an object that is stored by a storage node.

Beginning in block 403, the storage node that has previously stored the data chunk receives a request from the storage manager to retrieve the data chunk. The request may be in response to a request from client device to access an object of which the data chunk is a part and/or in response to operations internal to the storage system, such as a re-distribution of data stored among the storage nodes. In some embodiments, if the storage node receives a request for a data chunk that it cannot locate, the storage node may presume that it has lost the data chunk and request recovery of the data chunk, proceeding as described below starting in block 415. Next, in block 406, the storage node re-computes the checksum of the requested data chunk, where the computation includes reading the data chunk as it is stored in the storage medium of the storage node. As can be appreciated, the storage node may use MD-4/5, SHA-0/1/2/3, and/or other possible cryptographic hash algorithms to compute the checksum. Any change in the content of the data chunk from the time it was originally stored by the storage node, such as can occur with silent data loss, will result in a changed checksum value.

Then, in block 409, the storage node determines whether the stored checksum for the data chunk matches the re-calculated checksum by performing a comparison. If the checksums match, (i.e. verifying the integrity of the checksum) execution proceeds to block 412 where the data chunk is provided to the storage manager or other possible requestor. Alternatively, if the checksums for the data chunk do not match (i.e. the data chunk is corrupted), in block 415, the storage node can request the storage manager to recover the data chunk, where the recovery may be based on the remaining data chunks stored for the object.

Subsequently, in block 418, the storage node determines whether the storage manager has been able to recover the data chunk. If not, in block 421, the storage node deletes the data chunk and any other data chunks stored for the object by the storage node. Alternatively, in block 424, the storage node receives the recovered data chunk from the storage manager and stores the data chunk in its storage medium. Thereafter, execution of this portion of the functionality of the storage node ends as shown.

### Variations

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

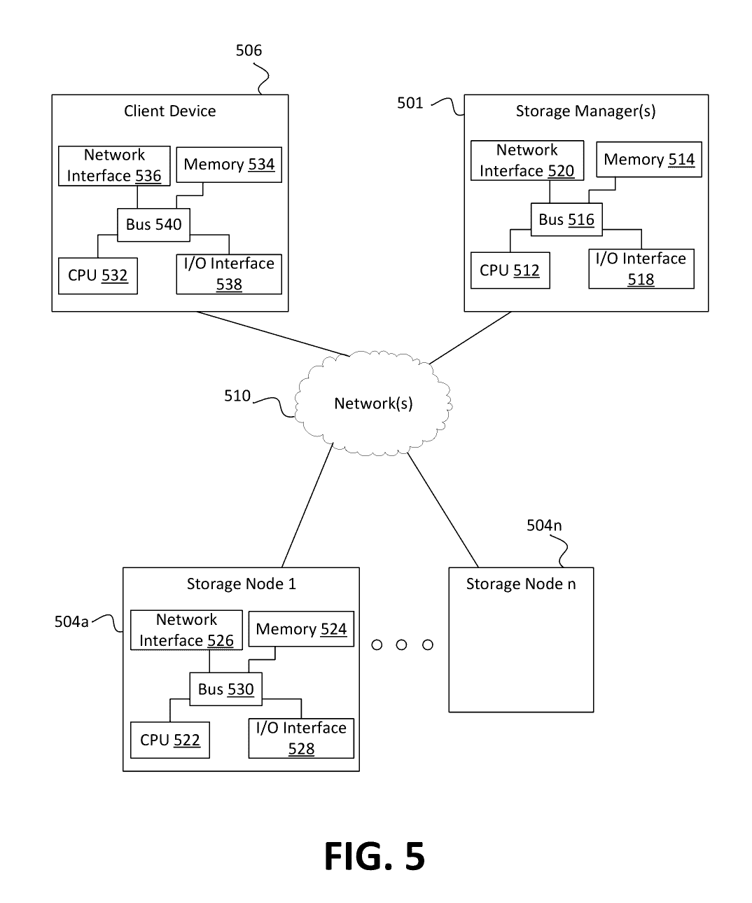

FIG. 5 is a block diagram illustrating an environment in which certain embodiments may be implemented. The environment may include one or more storage managers 501, a plurality of storage nodes 504a . . . 504n, and one or more client devices 506. The storage manager(s) 501, storage nodes 504a . . . 504n, and client device(s) 506 may be interconnected by one or more networks 510. The network(s) 510 may be or include, for example, one or more of a local area network (LAN), a wide area network (WAN), a storage area network (SAN), the Internet, or any other type of communication link or combination of links. In addition, the network(s) 510 may include system busses or other fast interconnects.

The system shown in FIG. 5 may be any one of an application server farm, a storage server farm (or storage area network), a web server farm, a switch or router farm, or any other type of storage network. Although one storage manager 501, n storage nodes 504a . . . 504n, and one client 506 are shown, it is to be understood that the environment may include more or less of each type of device, as well as other commonly deployed network devices and components, depending on the particular application and embodiment(s) to be implemented. The storage manager 501 may be, for example, computers such as application servers, storage servers, web servers, etc. Alternatively or additionally, storage manager 501 could be or include communication modules, such as switches, routers, etc., and/or other types of machines. Although the storage manager 501 is represented as a single device, it may be implemented as a distributed machine, which has multiple nodes that form a distributed and parallel processing system.

The storage manager 501 may include one or more CPU 512, such as a microprocessor, microcontroller, application-specific integrated circuit (“ASIC”), state machine, or other processing device etc. The CPU 512 executes computer-executable program code comprising computer-executable instructions for causing the CPU 512, and thus the storage manager 501, to perform certain methods and operations. For example, the computer-executable program code can include computer-executable instructions for causing the CPU 512 to execute a storage operating system that manages the storage and retrieval of data, in part by employing erasure codes associated with encoding, recovering, and decoding data chunks in the various storage nodes 504a . . . 504n. The CPU 512 may be communicatively coupled to a memory 514 via a bus 516 for accessing program code and data stored in the memory 514.

The memory 514 can comprise any suitable non-transitory computer readable media that stores executable program code and data. For example, the computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read instructions. The program code or instructions may include processor-specific instructions generated by a compiler and/or an interpreter from code written in any suitable computer-programming language, including, for example, C, C++, C#, Visual Basic, Java, Python, Perl, JavaScript, and ActionScript. Although not shown as such, the memory 514 could also be external to a particular storage manager 501, e.g., in a separate device or component that is accessed through a dedicated communication link and/or via the network(s) 510. A storage manager 501 may also comprise any number of external or internal devices, such as input or output devices. For example, storage manager 501 is shown with an input/output (“I/O”) interface 518 that can receive input from input devices and/or provide output to output devices.

A storage manager 501 can also include at least one network interface 520. The network interface 520 can include any device or group of devices suitable for establishing a wired or wireless data connection to one or more of the networks 510 or directly to a network interface 526 of a storage node 504a . . . 504n and/or a network interface 536 of a client device 506. Non-limiting examples of a network interface 520, 526, 536 can include an Ethernet network adapter, a modem, and/or the like to establish an TCP/IP connection with a storage node 504a . . . 504n, or a SCSI interface, USB interface, or a fiber channel interface to establish a direct connection with a storage node 504a . . . 504n.

Each storage node 504a . . . 504n may include similar components to those shown and described for the storage manager 501. For example, storage nodes 504a . . . 504n may include a CPU 522, memory 524, a network interface 526, and an I/O interface 528 all communicatively coupled via a bus 530. The components in storage node 504a . . . 504n function in a similar manner to the components described with respect to the storage manager 501. By way of example, the CPU 522 of a storage node 504a . . . 504n may execute computer-executable instructions for storing, retrieving and processing data in memory 524, which includes the methods described herein for detecting corrupted or lost data chunks, as well as communicating with storage manager 501 to initiate recovery of those data chunks. As can be appreciated, the storage nodes 504a . . . 504n may include multiple tiers of internal and/or external memories that may be used as storage media for data including the data chunks.

The storage manager 501 can be coupled to one or more storage node(s) 504a . . . 504n. Each of the storage nodes 504a . . . 504n could be an independent memory bank. Alternatively, storage nodes 504a . . . 504n could be interconnected, thus forming a large memory bank or a subcomplex of a large memory bank. Storage nodes 504a . . . 504n may be, for example, storage disks, magnetic memory devices, optical memory devices, flash memory devices, combinations thereof, etc., depending on the particular implementation and embodiment. In some embodiments, each storage node 504a . . . 504n may include multiple storage disks, magnetic memory devices, optical memory devices, flash memory devices, etc. Each of the storage nodes 504a . . . 504n can be configured, e.g., by the storage manager 501 or otherwise, to serve as a systematic node or a parity node in accordance with the various embodiments described herein.

A client device 506 may also include similar components to those shown and described for the storage manager 501. For example, a client device 506 may include a CPU 532, memory 534, a network interface 536, and an I/O interface 538 all communicatively coupled via a bus 540. The components in a client device 506 function in a similar manner to the components described with respect to the storage manager 501. By way of example, the CPU of a client device 506 may execute computer-executable instructions for storing and retrieving data objects, such as files, from a storage system managed by the storage manager 501, as described herein. Such computer-executable instructions and other instructions and data may be stored in the memory 534 of the client device 506 or in any other internal or external memory accessible by the client device 506.

It will be appreciated that the depicted storage manager 501, storage nodes 504a . . . 504n, and client device 506 are represented and described in relatively simplistic fashion and are given by way of example only. Those skilled in the art will appreciate that an actual storage manager, storage nodes, client devices, and other devices and components of a storage network may be much more sophisticated in many practical applications and embodiments. In addition, the storage manager 501 and storage nodes 504a . . . 504n may be part of an on-premises system and/or may reside in cloud-based systems accessible via the networks 510.

While the aspects of the disclosure are described with reference to various implementations and exploitations, it will be understood that these aspects are illustrative and that the scope of the claims is not limited to them. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method of detecting silent data loss comprising:
computing a first checksum for a first chunk of a plurality of chunks stored in a distributed storage system, wherein the plurality of chunks comprise chunks of systematic data and chunks of parity data generated from erasure coding a data object;
comparing the first checksum against a second checksum to verify integrity of the first chunk, wherein the second checksum was previously computed for the first data chunk and associated with the first chunk in the distributed storage system; and
based on a determination that the first checksum and the second checksum differ, initiating recovery of the first chunk using other chunks of the plurality of chunks.

2. The method of claim 1, wherein initiating recovery of the first chunk using the other chunks in the plurality of chunks comprises:
computing a current checksum for each of the other chunks of the plurality of chunks;
comparing the current checksums for the other chunks to checksums stored along with each of the other chunks to verify integrity of each of the other chunks; and
determining whether integrity has been successfully verified for a minimum number of the other chunks needed to recover the first chunk, wherein integrity of a chunk is successfully verified when a current checksum matches a stored checksum.

3. The method of claim 2 further comprising:
in response to determining that integrity could not be successfully verified for the minimum number of the other chunks needed to recover the first chunk, deleting the plurality of chunks.

4. The method of claim 2 further comprising:
in response to determining that integrity was successfully verified for the minimum number of the other chunks needed to recover the first chunk,
using the other chunks for which integrity was successfully verified to recover the first chunk; and
storing the recovered first chunk along with the second checksum.

5. The method of claim 1, wherein comparing the first checksum against the second checksum to verify integrity of the first chunk is in response to receipt of a request for the data object.

6. The method of claim 1, wherein comparing the first checksum against the second checksum to verify integrity of the first chunk is in response to expiration of a period of time.

7. The method of claim 6 further comprising, based on a number of chunks failing integrity verification, shortening the period of time to increase a frequency with which chunks are randomly selected for verification.

8. One or more non-transitory machine-readable media comprising program code for detection of silent data loss, the program code to:
determine a plurality of checksums for a plurality of chunks which were generated from erasure coding a data object;
store each of the plurality of checksums in association with a corresponding one of the plurality of chunks in a distributed storage system;
after the plurality of checksums and the plurality of chunks have been stored in the distributed storage system,
determine a first checksum for a first chunk of the plurality of chunks as read from the distributed storage system;
compare the first checksum against the one of the plurality of checksums associated with the first chunk in the distributed storage system to verify integrity of the first chunk as read from the distributed storage system;
based on the first checksum differing from the one of the plurality of checksums associated with the first chunk in the distributed storage system, initiate recovery of the first chunk in accordance with the erasure coding of the data object and verification of integrity of at least a subset of the plurality of chunks as read from the distributed storage system.

9. The machine-readable media of claim 8, wherein the program code to initiate recovery of the first chunk in accordance with the erasure coding of the data object and verification of integrity of at least the subset of the plurality of chunks as read from the distributed storage system comprises program code to:
determine a current checksum for each of the other chunks of the plurality of chunks;
compare the current checksums for the other chunks to checksums stored along with each of the other chunks to verify integrity of each of the other chunks; and
determine that integrity has been successfully verified for a minimum number of the other chunks needed to recover the first chunk, wherein integrity of a chunk is successfully verified when a current checksum matches a stored checksum, wherein the subset of the plurality of chunks comprises the minimum number of chunks for which integrity was successfully verified.

10. The machine-readable media of claim 9 further comprising program code to:
in response to the determination that integrity was successfully verified for the minimum number of the other chunks needed to recover the first chunk,
use the other chunks for which integrity was successfully verified to recover the first chunk; and
store the recovered first chunk along with the first checksum.

11. The machine-readable media of claim 8 further comprising program code to:
in response to a determination that integrity could not be successfully verified for at least the subset of the plurality of chunks, delete the plurality of chunks;
wherein a number of chunks in the subset of the plurality of chunks is equal to a minimum number of the other chunks needed to recover the first chunk.

12. The machine-readable media of claim 8, wherein the program code to determine and compare the first checksum to verify integrity of the first chunk is in response to receipt of a request for the data object.

13. The machine-readable media of claim 8, wherein the program code to determine and compare the first checksum to verify integrity of the first chunk is in response to expiration of a period of time.

14. The machine-readable media of claim 13 further comprising program code to, based on a number of chunks failing integrity verification, shorten the period of time to increase a frequency with which chunks are randomly selected for verification.

15. An apparatus comprising:
a processor; and
a machine-readable medium having program code executable by the processor to cause the apparatus to,
compute a first checksum for a first chunk of a plurality of chunks stored in a distributed storage system, wherein the plurality of chunks comprise chunks of systematic data and chunks of parity data generated from erasure coding a data object;
compare the first checksum against a second checksum to verify integrity of the first chunk, wherein the second checksum was previously computed for the first data chunk and associated with the first chunk in the distributed storage system; and
based on a determination that the first checksum and the second checksum differ, initiate recovery of the first chunk using other chunks of the plurality of chunks.

16. The apparatus of claim 15, wherein the program code executable by the processor to cause the apparatus to initiate recovery of the first chunk using the other chunks in the plurality of chunks comprises program code executable by the processor to cause the apparatus to:
compute a current checksum for each of the other chunks of the plurality of chunks;
compare the current checksums for the other chunks to checksums stored along with each of the other chunks to verify integrity of each of the other chunks; and
determine whether integrity has been successfully verified for a minimum number of the other chunks needed to recover the first chunk, wherein integrity of a chunk is successfully verified when a current checksum matches a stored checksum.

17. The apparatus of claim 16 further comprising program code executable by the processor to cause the apparatus to:
in response to a determination that integrity could not be successfully verified for the minimum number of the other chunks needed to recover the first chunk, delete the plurality of chunks.

18. The apparatus of claim 16 further comprising program code executable by the processor to cause the apparatus to:
in response to a determination that integrity was successfully verified for the minimum number of the other chunks needed to recover the first chunk,
use the other chunks for which integrity was successfully verified to recover the first chunk; and
store the recovered first chunk along with the second checksum.

19. The apparatus of claim 15, wherein the program code executable by the processor to cause the apparatus to compare the first checksum against the second checksum to verify integrity of the first chunk is in response to expiration of a period of time.

20. The apparatus of claim 19 further comprising program code executable by the processor to cause the apparatus to, based on a threshold number of chunks failing integrity verification, shorten the period of time to increase a frequency with which chunks are randomly selected for verification.
